(19) United States
(12) Patent Application Publication
(10) Pub. No.: US 2015/0324690 A1
(43) Pub. Date: Nov. 12, 2015

(54) Deep Learning Training System

(71) Applicant: Microsoft Corporation, Redmond, WA (US)

(72) Inventors: Trishul A. Chilimbi, Seattle, WA (US); Yutaka Suzue, Issaquah, WA (US); Johnson R. Apacible, Mercer Island, WA (US); Karthik Kalyanaraman, Redmond, WA (US)

(21) Appl. No.: 14/492,270

(22) Filed: Sep. 22, 2014

Related U.S. Application Data
(60) Provisional application No. 61/990,708, filed on May 8, 2014.

(51) Int. Cl. G06N 3/08; G06N 3/063

(52) U.S. Cl. CPC G06N 3/08; G06N 3/063

(57) ABSTRACT

Training large neural network models by providing training input to model training machines organized as multiple replicas that asynchronously update a shared model via a global parameter server is described herein. In at least one embodiment, a system including a model module storing a portion of a model and a deep learning training module that communicates with the model module are configured for asynchronously sending updates to shared parameters associated with the model. The techniques herein describe receiving and processing a batch of data items to calculate updates. Replicas of training machines communicate asynchronously with a global parameter server to provide updates to a shared model and return updated weight values. The model may be modified to reflect the updated weight values. The techniques described herein include computation and communication optimizations that improve system efficiency and scaling of large neural networks.

### RELATED APPLICATIONS

This application claims the benefit of U.S. Provisional Application No. 61/990,708, filed on May 8, 2014, the entire contents of which are incorporated herein by reference.

### BACKGROUND

Traditional statistical machine learning operates with a table of data and a prediction goal. The rows of the table correspond to independent observations and the columns correspond to hand crafted features of the underlying data set. FIG. 1 is a diagram showing an example system 100 for statistical machine learning operations. As shown in FIG. 1, training data 102 is provided to humans 104 for labeling. The training data 102 and/or human labeled data (as output from humans 104) may also be processed to correspond to hand-crafted features 106 associated with the training data set 102. Then a variety of machine learning algorithms can be applied to learn a classifier 108 that maps each data row to a prediction 110. The classifier 108 may process the training data 102 to calculate errors 112 and update the classifier 108. More importantly, the classifier 108 may also process unseen test data 114 that is drawn from a similar distribution as the training data and make predictions 116 based on the unseen test data 114.

Traditional statistical machine learning works well for many problems such as recommendation systems where a human domain expert can easily construct a good set of features. Unfortunately, it fails for hard artificial intelligence tasks such as speech recognition or visual object classification where it is extremely hard to construct appropriate features over the input data. Deep learning attempts to address this shortcoming by additionally learning hierarchical features from the raw input data and using the hierarchical features to make predictions. FIG. 2 is a diagram 200 showing deep networks learning complex representations.

As shown in FIG. 2, computing machines called neurons (e.g., v₁, v₂, v₃, etc.) associated with the first layer 202 receive an input 204. The first layer 202 represents the input layer. Each of the individual neurons in the first layer 202 outputs a single output to each of the neurons in the second layer 206 of neurons via connections between the neurons in each layer. The second layer 206 represents a layer for learning low-level features. Accordingly, each neuron in the second layer 206 receives multiple inputs and outputs a single output to each of the neurons in the third layer 208. The third layer 208 represents a layer for learning mid-level features. A same process happens for layer 210, which represents a layer for learning high-level features, and layer 212, which represents a layer for learning desired outputs. In layer 212, the output comprises a label 214 representative of the input 204.

Deep learning has recently enjoyed success on speech recognition and visual object recognition tasks primarily because of advances in computing capability for training these models. Because learning hierarchical features is more difficult than optimizing models for prediction, deep learning requires significantly more training data and computing power to be successful.

In some embodiments, complex tasks require deep models with a large number of parameters that have to be trained. Such large models require significant amounts of data for successful training to prevent over-fitting on the training data which leads to poor generalization performance on unseen test data. FIGS. 3A and 3B illustrate graphs 300 and 302 illustrating an improvement in accuracy in view of increasing amounts of data and increasing model sizes. Unfortunately, increasing model size and training data, requires significant amounts of computing cycles as illustrated in FIG. 4. FIG. 4 is a diagram 400 illustrating deep learning computational requirements.

Deep models may be trained on graphics processing units (GPUs). While this works well when the model fits within 2-4 GPU cards attached to a single server, it limits the size of models that can be trained. For example, known embodiments include a large-scale distributed system comprised of commodity servers to train extremely large models to high accuracy on a hard visual object recognition task—classifying images into one of twenty-two thousand distinct categories using raw pixel information. Unfortunately, such embodiments scale poorly and are not viable cost-effective options for training large deep neural networks (DNNs).

Other known embodiments, describe large-scale distributed systems comprised of tens of thousands of CPU cores for training large deep neural networks, as shown in FIG. 5. The system architecture 500 shown in FIG. 5 leverages model and data parallelism. Model worker machines are arranged into model replicas such as 502A, 502B, and 502C. Large models are partitioned across the multiple model worker machines in each model replica (e.g., 502A-C) enabling the model computation to proceed in parallel. Large models require significant amounts of data 504 for training so the system allows multiple replicas of the same model to be trained in parallel on different partitions of the training data set. The model replicas (e.g., 502A-C) share a common set of parameters that is stored on a global parameter server 506. For speed of operation each model replica (e.g., 502A-C) operates in parallel and asynchronously publishes model weight updates (e.g., W, ΔW) to and receives updated parameter weights from the parameter server 506. While these asynchronous updates result in inconsistencies in the shared model parameters, neural networks are a resilient learning architecture and such embodiments have demonstrated successful training of large models to world-record accuracy on a visual object recognition tasks.

### SUMMARY

Systems and methods to train large neural network models by providing training input to model training machines organized as multiple replicas that asynchronously update a shared model via a global parameter server are described herein. The techniques described herein describe training any combination of stacked convolutional and fully-connected network layers for speech and/or visual object recognition, text processing, and other tasks. The systems and methods described herein include computation and communication optimizations that improve system efficiency and scaling of large neural networks.

In at least one embodiment, the techniques herein describe a system including a model module configured for storing a portion of a model and a deep learning training module configured for communicating with the model module. In the at least one embodiment, the deep learning training module is further configured for asynchronously sending updates to shared parameters associated with the model. In some embodiments, the techniques described herein include methods for arranging computing devices into groups of computing devices and individual groups are associated with a model. The techniques herein describe partitioning the model across the computing devices in each individual group such that neurons in a layer of the model have vertical proximities within a predetermined threshold to neurons in neighboring layers of the model.

In additional embodiments, the techniques described herein include receiving a batch of data items and processing individual data items of the batch of data items to calculate updates. The systems described herein may asynchronously send the updates to shared parameters stored in a global parameter server. The global parameter server may asynchronously return updated weight values to the systems described herein based on the updates to the shared parameters. In the additional embodiments, the model may be modified to reflect the updated weight values.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

### DESCRIPTION OF FIGURES

The Detailed Description is described with reference to the accompanying figures. In the figures, the left-most digit(s) of a reference number identifies the figure in which the reference number first appears. The same reference numbers in different figures indicate similar or identical items.

FIG. 1 is a diagram showing an example system for statistical machine learning operations.

FIG. 2 is a diagram showing deep networks learning complex representations.

FIG. 3A is a graph illustrating an improvement in accuracy in view of increasing amounts of data.

FIG. 3B is a graph illustrating an improvement in accuracy in view of increasing model sizes.

FIG. 4 is a diagram illustrating deep learning computational requirements.

FIG. 5 is a diagram showing a large-scale distributed system for training large deep neural networks.

FIG. 6 is a diagram illustrating a system for deep learning training as described herein.

FIG. 7 is a diagram illustrating the system for deep learning training as described in FIG. 6 with more detail, including partitioning models across training machines.

FIG. 8 is a diagram illustrating an architecture of the global parameter server(s) of FIGS. 6 and 7.

FIG. 9 is a flow diagram illustrating deep learning training as described herein.

FIG. 10 is a flow diagram illustrating deep learning training as described herein.

FIG. 11 is a flow diagram illustrating process for training a model based on asynchronous communication with shared parameters.

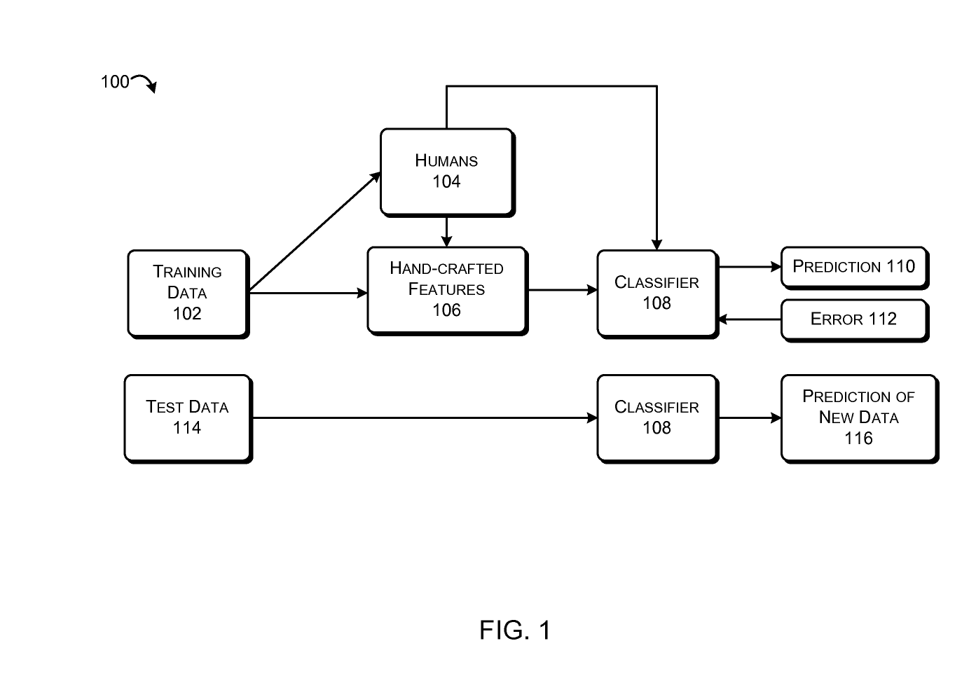

### DETAILED DESCRIPTION

Systems and methods of a scalable distributed deep learning training system comprised of commodity servers to train large neural network models for providing training input to model training machines organized as multiple replicas that asynchronously update a shared model via a global parameter server are described herein. The techniques described herein describe training any combination of stacked convolutional and fully-connected network layers for speech and/or visual object recognition, text processing, and other tasks.

The systems and methods described herein include computation and communication optimizations that improve system efficiency and scaling of large neural networks. The systems and methods described herein may be leveraged to improve performance and scaling characteristics by using fewer machines to train a large (e.g., 2 billion, etc.) connection model to a higher accuracy (e.g., 2× higher accuracy) in comparable time on the category image classification task (e.g., ImageNet 22,000) than known embodiments that previously held the record for this benchmark. Additionally, the systems and methods described herein may be leveraged to drive large-scale deep learning where prediction accuracy may be increased by training larger models on vast amounts of data using efficient and scalable compute clusters, rather than relying on algorithmic breakthroughs from the machine learning community.

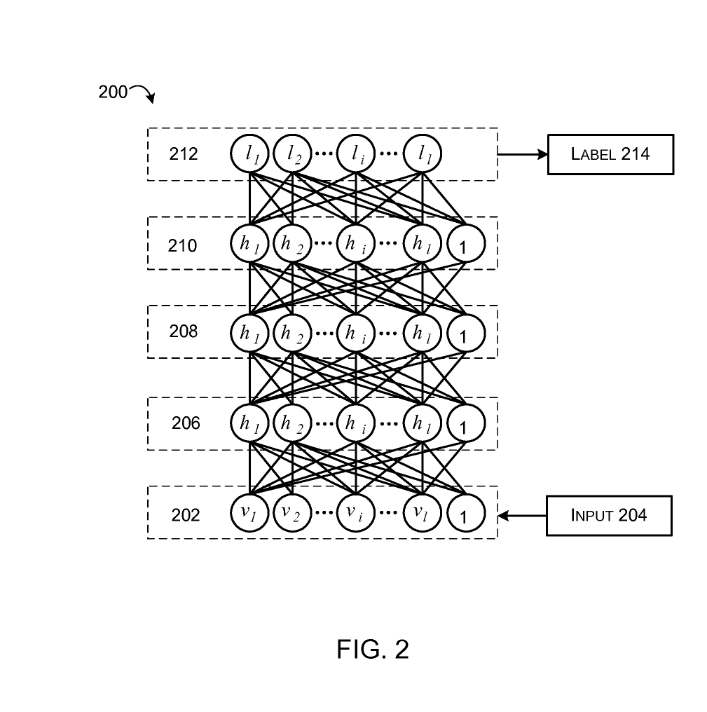

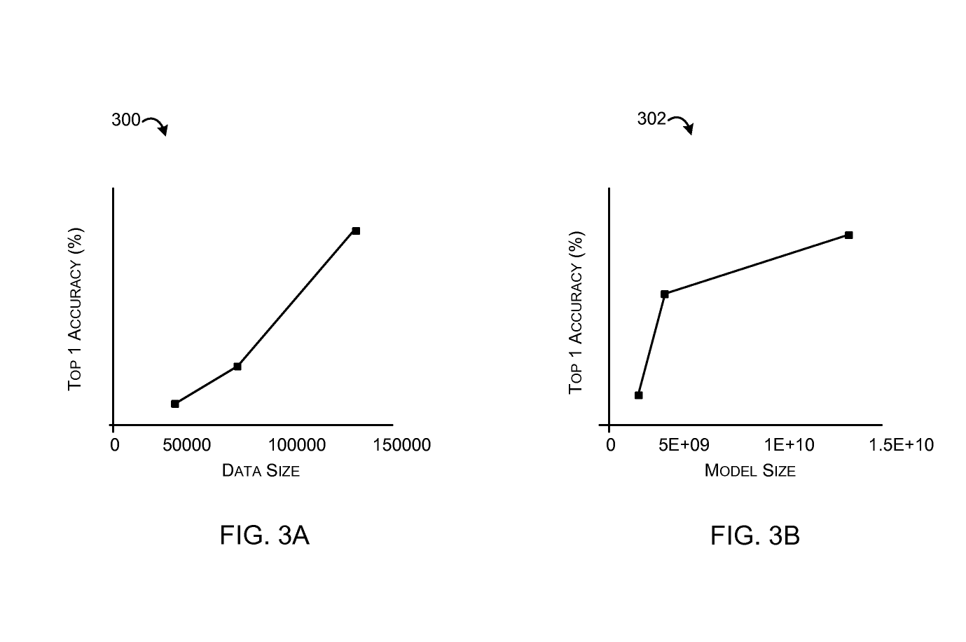

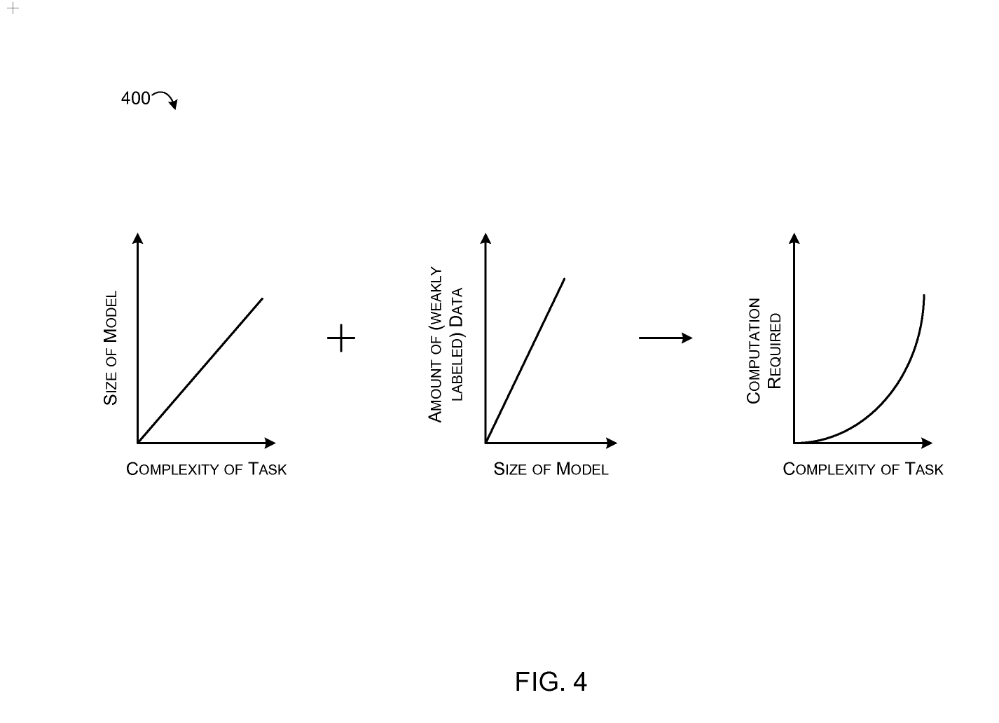

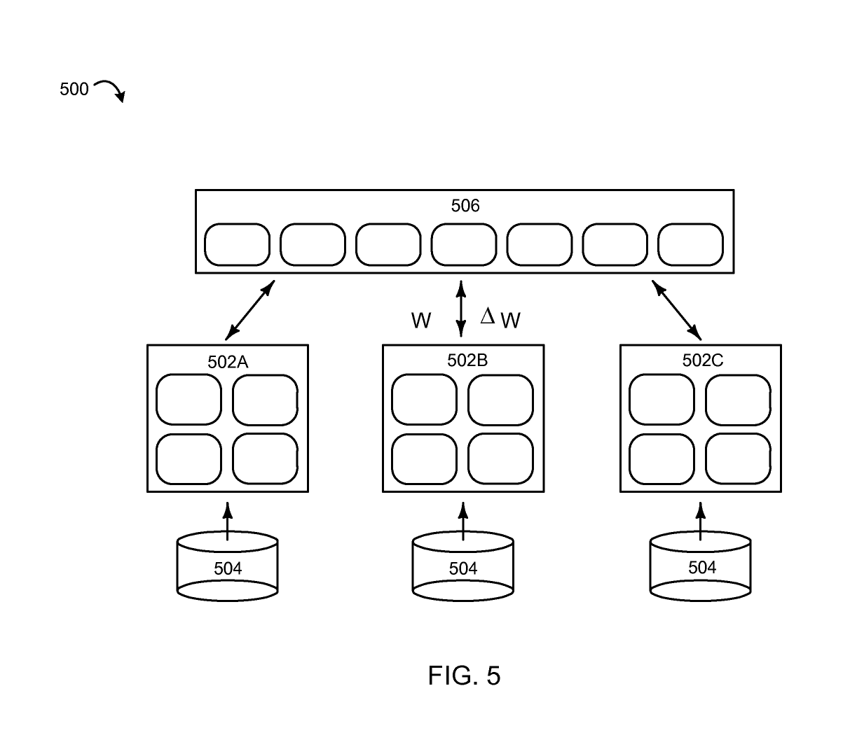

Neural networks consist of large numbers of homogeneous computing units called neurons with multiple inputs and a single output. These are typically connected in a layer-wise manner (e.g., layers 202-212) with the output of neurons in layer l−1 connected to all neurons in layer l, as in FIG. 2. Deep learning describes learning that includes learning hierarchical features from raw input data (e.g., 102, 204) and leveraging such learned features to make predictions (e.g., 110, 116, 214) associated with the raw input data (e.g., 102, 204). Deep learning models include deep neural networks (DNN), convolutional deep neural networks, deep belief networks, etc. DNNs have multiple layers that enable hierarchical feature learning, as described above.

In at least one embodiment, an output of a neuron i in layer l, called the activation, is computed as a function of its inputs as follows:

aᵢ(l)=F((Σ_{j=1 . . . k}wᵢⱼ(l−1,l)*aⱼ(l−1))+bᵢ)

where wᵢⱼ is the weight associated with the connection between neurons i and j and bᵢ is a bias term associated with neuron i. The weights and bias terms constitute the parameters of the network to be learned to accomplish the specified task. The activation function, F, associated with individual neurons in the network is a pre-defined non-linear function. In some embodiments, the activation function includes a sigmoid or hyperbolic tangent.

Convolutional neural networks may represent a class of neural networks that are biologically inspired by early work on the visual cortex. Neurons in a layer may be connected to spatially local neurons in the next layer modeling local visual receptive fields. In addition, these connections may share weights which allows for feature detection regardless of position in the visual field. The weight sharing may also reduce the number of free parameters to be learned and consequently these models are easier to train compared to similar size networks where neurons in a layer are fully connected to every neuron in a neighboring layer.

Visual tasks may leverage large scale neural networks for learning visual features. Recent work has demonstrated that DNNs comprised of convolutional layers (e.g., 5 convolutional layers) for learning visual features followed by fully connected layers (e.g., 3 fully connected layers) for combining these learned features to make a classification decision may achieve state-of-the-art performance on visual object recognition tasks. The DNNs may be used to train models on tasks such as speech recognition, text processing, and/or other tasks also.

In at least one embodiment, neural networks may be trained by back-propagation using gradient descent. Stochastic gradient descent is a variant that is often used for scalable training as it minimizes cross-machine communication. In stochastic gradient descent the training inputs are processed in a random order. The inputs may be processed one at a time with the following steps performed for each input to update the model weights.

### Feed-Forward Evaluation

Activation a describes the output of each neuron i in a layer l. The activation a may be computed by a process called feed-forward evaluation. The activation a may be computed as a function of k inputs from neurons j in a preceding layer l−1 (or input data for the first layer). If wᵢⱼ(l−1,l) is the weight associated with a connection between neuron j in layer l−1 and neuron i in layer 1, then the feed-forward evaluation is as follows:

aᵢ(l)=F((Σ_{j=1 . . . k}wᵢⱼ(l−1,l)*aⱼ(l−1))+bᵢ),

where b is a bias term for the neuron i.

### Back-Propagation

Error terms, δ, are computed for each neuron i in the output layer lₙ, first as follows:

δᵢ(lₙ)=(tᵢ(lₙ)−aᵢ(lₙ))*F′(aᵢ(lₙ)),

where t(x) is the true value of the output and F′(x) is the derivative of F(x).

These error terms are then back-propagated for each neuron i in layer l connected to neurons m in layer l+1 as follows:

δᵢ(l)=(Σ_{j=l . . . m}δⱼ(l+1)*wⱼᵢ(l,l+1)).*F′(aᵢ(l)).

### Weight Updates

These error terms are used to update the weights (and biases similarly) as follows:

Δwᵢⱼ(l−1,l)=α*δᵢ(l)*aⱼ(l−1) for j=1 . . . k,

where α is the learning rate parameter. This process may be repeated for each input until the entire training dataset has been processed, which constitutes a training epoch. At the end of a training epoch, the model prediction error may be computed on a held out validation set. Typically, training continues for multiple epochs, reprocessing the training data set each time, until the validation set error converges to a desired value below a predetermined threshold. The trained model is then evaluated on (unseen) test data (e.g., 114).

### Illustrative Environment

The environment described below constitutes but one example and is not intended to limit application of the system described below to any one particular operating environment. Other environments may be used without departing from the spirit and scope of the claimed subject matter. The various types of processing described herein may be implemented in any number of environments including, but not limited to, stand along computing systems, network environments (e.g., local area networks or wide area networks), peer-to-peer network environments, distributed-computing (e.g., cloud-computing) environments, etc.

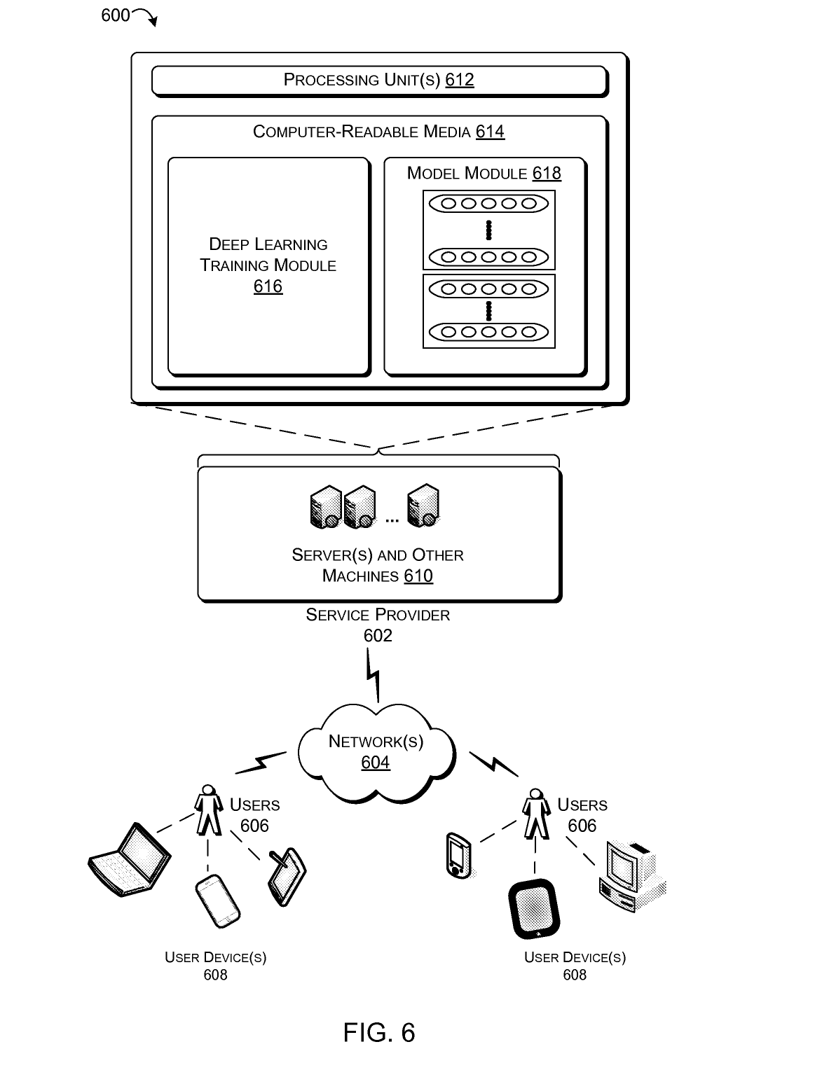

FIG. 6 illustrates an example operating environment 600 that includes a variety of devices and components that may be implemented in a variety of environments for providing training input to model training machines organized as multiple replicas that asynchronously update a shared model via a global parameter server.

More particularly, the example operating environment 600 may include a service provider 602, one or more network(s) 604, one or more users 606, and one or more user devices 608 associated with the one or more users 606. Alternatively, or in addition, the functionality described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

As shown, the service provider 602 may include one or more server(s) and other machines 610, any of which may include one or more processing unit(s) 612 and computer-readable media 614. In various embodiments, the service provider 602 may train large neural network models for speech and/or visual object recognition, text processing, and other tasks.

In some embodiments, the network(s) 604 may be any type of network known in the art, such as the Internet. Moreover, the user devices 608 may communicatively couple to the network(s) 604 in any manner, such as by a global or local wired or wireless connection (e.g., local area network (LAN), intranet, etc.). The network(s) 604 may facilitate communication between the server(s) 610 and the user devices 608 associated with the users 606.

In some embodiments, the users 606 may operate corresponding user devices 608 to perform various functions associated with the user devices 608, which may include one or more processing unit(s), computer-readable storage media, and a display. Furthermore, the users 606 may utilize the user devices 608 to communicate with other users 606 via the one or more network(s) 604.

User device(s) 608 can represent a diverse variety of device types and are not limited to any particular type of device. Examples of device(s) 608 can include but are not limited to stationary computers, mobile computers, embedded computers, or combinations thereof. Example stationary computers can include desktop computers, work stations, personal computers, thin clients, terminals, game consoles, personal video recorders (PVRs), set-top boxes, or the like. Example mobile computers can include laptop computers, tablet computers, wearable computers, implanted computing devices, telecommunication devices, automotive computers, personal data assistants (PDAs), portable gaming devices, media players, cameras, or the like. Example embedded computers can include network enabled televisions, integrated components for inclusion in a computing device, appliances, microcontrollers, digital signal processors, or any other sort of processing device, or the like.

The service provider 602 may be any entity, server(s), platform, etc., that may leverage a collection of features from communication platforms, including online communication platforms, to measure the interaction dynamics between users of the communication platforms. Moreover, and as shown, the service provider 602 may include one or more server(s) and other machines 610, which may include one or more processing unit(s) 612 and computer-readable media 614 such as memory. The one or more server(s) and other machines 610 may include devices.

Embodiments support scenarios where device(s) that may be included in the one or more server(s) and other machines 610 can include one or more computing devices that operate in a cluster or other grouped configuration to share resources, balance load, increase performance, provide fail-over support or redundancy, or for other purposes. Device(s) included in the one or more server(s) and other machines 610 can belong to a variety of categories or classes of devices such as traditional server-type devices, desktop computer-type devices, mobile devices, special purpose-type devices, embedded-type devices, and/or wearable-type devices. Thus, although illustrated as desktop computers, device(s) can include a diverse variety of device types and are not limited to a particular type of device. Device(s) included in the one or more server(s) and other machines 610 can represent, but are not limited to, desktop computers, server computers, web-server computers, personal computers, mobile computers, laptop computers, tablet computers, wearable computers, implanted computing devices, telecommunication devices, automotive computers, network enabled televisions, thin clients, terminals, personal data assistants (PDAs), game consoles, gaming devices, work stations, media players, personal video recorders (PVRs), set-top boxes, cameras, integrated components for inclusion in a computing device, appliances, or any other sort of computing device.

Device(s) that may be included in the one or more server(s) and other machines 610 can include any type of computing device having one or more processing unit(s) 612 operably connected to computer-readable media 614 such as via a bus, which in some instances can include one or more of a system bus, a data bus, an address bus, a PCI bus, a Mini-PCI bus, and any variety of local, peripheral, and/or independent buses. Executable instructions stored on computer-readable media 614 can include, for example, a deep learning training engine 616, and other modules, programs, or applications that are loadable and executable by processing units(s) 612. Alternatively, or in addition, the functionality described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Device(s) that may be included in the one or more server(s) and other machines 610 can further include one or more input/output (I/O) interface(s) coupled to the bus to allow device(s) to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like). Devices that may be included in the one or more server(s) and other machines 610 can also include one or more network interfaces coupled to the bus to enable communications between computing device and other networked devices such as user device(s) 608. Such network interface(s) can include one or more network interface controllers (NICs) or other types of transceiver devices to send and receive communications over a network. For simplicity, some components are omitted from the illustrated device.

Processing unit(s) 612 and can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc. In various embodiments, the processing unit(s) 612 may execute one or more modules and/or processes to cause the server(s) and other machines 610 to perform a variety of functions, as set forth above and explained in further detail in the following disclosure. Additionally, each of the processing unit(s) 612 may possess its own local memory, which also may store program modules, program data, and/or one or more operating systems.

In at least one configuration, the computer-readable media 614 of the server(s) and other machines 610 may include components that facilitate interaction between the service provider 602 and the users 606. For example, the computer-readable media 614 may include the deep learning training module 616, the model module 618, and other modules. The modules (e.g., 616, 618, etc.) can be implemented as computer-readable instructions, various data structures, and so forth via at least one processing unit(s) 612 to configure a device to execute instructions and to perform operations implementing. Functionality to perform these operations may be included in multiple devices or a single device.

Depending on the exact configuration and type of the one or more server(s) and other machines 610, the computer-readable media 614 may include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer memory is an example of computer storage media. Thus, computer storage media includes tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, miniature hard drives, memory cards, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media may embody computer readable instructions, data structures, program modules, or other data in a modulated data signal, such as a carrier wave, or other transmission mechanism. The term “modulated data signal” means a signal that has one or more of its characteristics set or changed in such a manner as to encode information in the signal. Such signals or carrier waves, etc. can be propagated on wired media such as a wired network or direct-wired connection, and/or wireless media such as acoustic, RF, infrared and other wireless media. As defined herein, computer storage media does not include communication media. That is, computer storage media does not include communications media consisting solely of a modulated data signal, a carrier wave, or a propagated signal, per se.

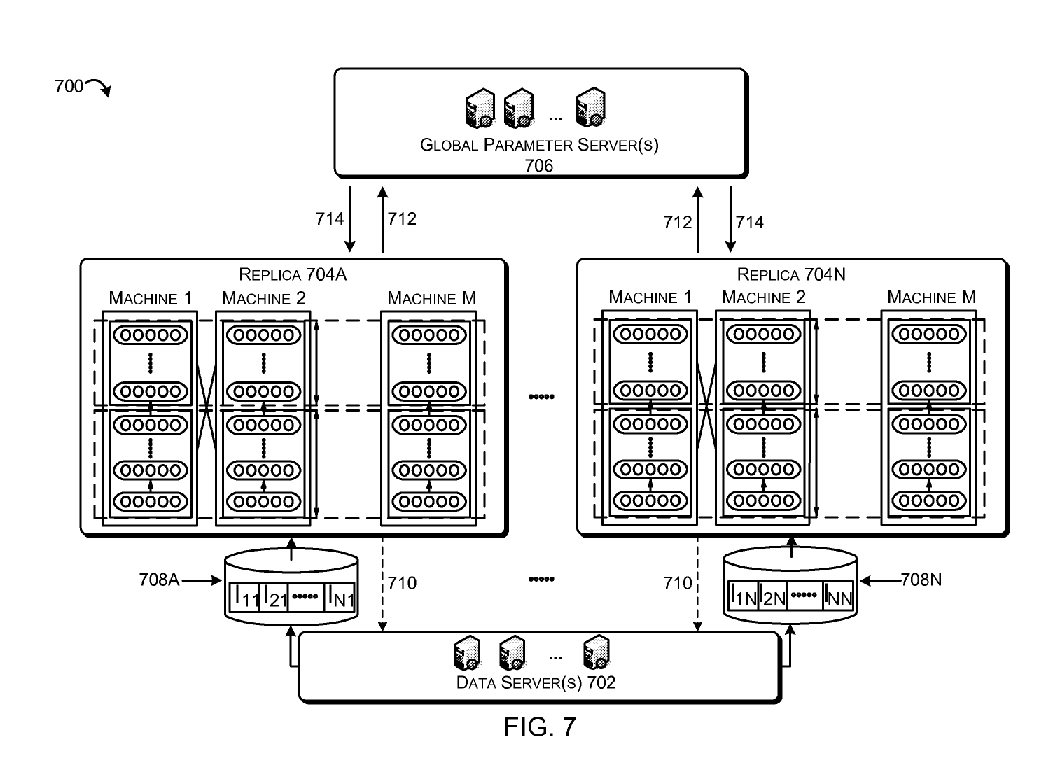

FIG. 7 is a diagram illustrating the system for deep learning training as described in FIG. 6 with more detail, including partitioning models across training machines. Data servers 702 may be any of the servers 610 in FIG. 6. The data servers 702 may be leveraged for fast data serving as described below. Replicas 704A-704N represent groups of computing devices or machines. Machines 1-M may be any of the machines 610 in FIG. 6. Each of the replicas 704A-704N may train a same (but duplicate) model. The individual machines (e.g., Machine 1, Machine 2, etc.) in each replica 704A-704N may each store portions of the model that is stored and trained in the replica 704A-704N. The replicas 704A-704N may be leveraged for model training as described below. The models trained on the replicas 704A-704N share a common set of parameters that may be stored on the global parameter server(s) 706. The global parameter server(s) 706 may be any of the servers 610 in FIG. 6. The global parameter server(s) 706 are discussed in more detail below.

### Fast Data Serving

In at least one embodiment, training large DNNs requires vast quantities of training data (e.g., 60-600 TBs). Even with large quantities of training data, these DNNs may undergo data transformations to avoid over-fitting when iterating through the data set multiple times. In some embodiments, a set of machines that may be one of the one or more servers and other machines 610 may be organized as data server(s) 702 to offload the computational requirements of these transformations from the model training machines (e.g., replicas 704A-704N) and ensure high throughput data delivery. The data server(s) 702 may serve batches of data 708A-708N from the training data set stored in the data server(s) 702 to the replicas 704A-704N.

In at least one embodiment, the data server(s) 702 may augment the training data set by randomly applying a different transformation to each image data items so that each training epoch effectively processes a different variant of the same image. For visual object classification, the transformations may include translations, reflections, and rotations. This may be done in advance so that the transformed images may be streamed to the model training machines (e.g., replicas 704A-704N) when requested in batches of data 708A-708N. For speech recognition, these transformations could include de-noising the audio waveform or filtering certain frequencies.

In the at least one embodiment, the data server(s) 702 pre-cache data utilizing nearly the entire system memory as a data cache to speed data serving. The data server(s) 702 may use asynchronous input/output (I/O) to process incoming requests 710 from the replicas 704A-704N. The replicas 704A-704N representing groups of the model training machines (e.g., replicas 704A-704N) may request data in advance in batches using a background thread so that the main training threads have the required data in memory.

### Model Training

In some embodiments, models for vision tasks typically contain a number of convolutional layers followed by a few fully connected layers. In at least one embodiment, the models may be partitioned vertically across the model worker machines as shown in FIG. 7. As shown in FIG. 7, the models may be partitioned such that neurons in each of the layers are within a predetermined vertical distance to neurons in neighboring layers. Partitioning the models vertically across the replicas 704A-704N representing groups of the model worker machines may minimize the amount of cross-machine communication between the convolution layers.

### Multi-Threaded Training

In at least one embodiment, model training on a machine (e.g., Machine 1, Machine 2, etc.) may be multi-threaded with different data items assigned to threads that share the model weights. Each thread allocates a training context for feed-forward evaluation and back propagation, as described above. This training context may store the activations and weight update values computed during back-propagation for each layer. The context is pre-allocated to avoid heap locks while training. Both the context and per-thread scratch buffer for intermediate results may use non-uniform memory access (NUMA)-aware allocations to reduce cross-memory bus traffic as these structures are frequently accessed.

### Fast Weight Updates

To further accelerate training, in at least one embodiment, the systems and methods described herein may access and update the shared model weights without using locks. Each thread computes weight updates and updates the shared model weights. This may introduce some races as well as potentially modifying weights based on stale weight values that may be used to compute the weight updates but have since been changed by other threads. Models may still be trained to convergence despite this since the weight updates are associative and commutative and because neural networks are resilient and can overcome the small amount of noise that this introduces. This system is similar to the Hogwild system except the systems and methods described herein do not require that the models be sparse.

### Reducing Memory Copies

In at least one embodiment of model training, data values may be communicated across neuron layers. Since the model is partitioned across multiple machines (e.g., Machine 1, Machine 2, etc.) within each replica (e.g., 704A, 704N, etc.) some of this communication may be non-local. A uniform optimized interface may be used to accelerate this communication. Rather than copy data values, a pointer may be passed to the relevant block of neurons whose outputs need communication, avoiding expensive memory copies.

For non-local communication, a network library on top of an API (e.g., Windows socket, other sockets) with I/O completion ports may be used. This library may be compatible with a data transfer mechanism and may accept a pointer to a block of neurons whose output values need to be communicated across the network. In at least one embodiment, reference counting may be used to ensure safety in the presence of asynchronous network I/O. These optimizations may reduce the memory bandwidth and CPU requirements for model training.

### Memory System Optimizations

In at least one embodiment, models may be partitioned across multiple machines (e.g., Machine 1, Machine 2, etc.) within a replica 704A-704N such that the working sets for the model layers fit in the L3 cache. The L3 cache has higher bandwidth than memory and may maximize usage of the floating point units on the machine that would otherwise be limited by memory bandwidth.

In some embodiments, a computation for cache locality may be optimized. The forward evaluation and back-propagation computation may have competing locality requirements in terms of preferring a row major or column major layout for the layer weight matrix. In at least one embodiment, two custom hand-tuned assembly kernels that are optimized for each of these matrix multiply operations may be used to overcome the competing locality requirements.

### Mitigating the Impact of Slow Machines

In any large computing cluster, such as the cluster including replicas 704A-704N, there may be a variance in speed between machines even when all share the same hardware configuration. The systems and methods described herein may mitigate this speed variance. There are two places where this speed variance has an impact. First, since the model is partitioned across multiple machines (e.g., Machine 1, Machine 2, Machine M, etc.) the speed of processing an image is limited by slow machines. To avoid stalling threads on faster machines that are waiting for data values to arrive from slower machines, threads may process multiple images in parallel. A dataflow framework may be used to trigger progress on individual images based on arrival of data from remote machines. Second, the end of an epoch may cause speed variances because the system may need to wait for all training images to be processed to compute the model prediction error on the validation data set and determine whether an additional training epoch is necessary. In at least one embodiment, an epoch may be ended whenever a specified fraction (e.g., 75%, 70%, etc.) of the images are completely processed. To ensure that images in the same set of images are not skipped each epoch, image processing order may be randomized for each epoch. In an alternative embodiment, faster machines may be configured to steal work from the slower ones.

### Parameter Server Communication

Two different communication protocols for updating parameter weights are described herein. In one embodiment, a communication protocol locally computes and accumulates the weight updates in a buffer that is periodically sent to the global parameter server(s) 706 when a predetermined number, e.g., “k” (which is typically in the hundreds to thousands) of images (e.g., data items) have been processed. This communication is shown by arrows 712 in FIG. 7. The global parameter server(s) 706 then directly apply these accumulated updates to the stored weights. This works well for the convolutional layers since the volume of weights is low due to weight sharing.

For the fully connected layers that have many more weights, a different protocol to minimize communication traffic between the model training machines (e.g., Machine 1, Machine 2, etc.) and global parameter server(s) 706 may be used. In such an embodiment, rather than directly sending the weight updates, the activation and error gradient vectors may be sent to the global parameter server(s) 706, as shown by arrows 712 in FIG. 7, where the matrix multiply can be performed locally to compute and apply the weight updates. This significantly reduces the communication traffic volume from M*N to k*(M+N). In addition, such protocol has an additional beneficial aspect as it offloads computation from the model training machines (e.g., Machine 1, Machine 2, etc.) where the CPU is heavily utilized to the global parameter server(s) 706 where the CPU is underutilized.

The global parameter server(s) 706 may be in constant communication with the model training machines (e.g., Machine 1, Machine 2, etc.) receiving updates to model parameters and sending the current weight values. These communications are illustrated by arrows 712 and 714. Each of the replicas 704A-704N compute weight updates locally from the error and activation terms. The replicas 704A-704N send the weight updates and receive updated weight values asynchronously. For example, replica 704A sends weight updates to the global parameter server(s) 706 at a rate different from a rate that replica 704N sends weight updates to the global parameter server(s) 706. Each of the replicas 704A-704N may be completely unaware of the communications (e.g., 712, 714) that may be occurring between the other replicas. That is, each of the replicas 704A-704N processes the data items 708A-708N locally and communicates with the global parameter server(s) 706 at rates or intervals unique to each replica 704A-704N. Such local computation and asynchronous communication may offload computing from the deep learning training module 616 and minimizes communication between the deep learning training module 616 and the model module 618. The global parameter server(s) 706 combine the updates received from each of the replicas 704A-704N before the updates are applied to the stored shared parameters. The associative and commutative properties of the updates allow for the global parameter server(s) 706 to collect, combine, and/or aggregate the updates before the updates are applied to the stored shared parameters. Similarly, the individual replicas 704A-704N communicate with the data server(s) 702 asynchronously, without regard to the communications of the other replicas 704A-704N.

### Global Parameter Server

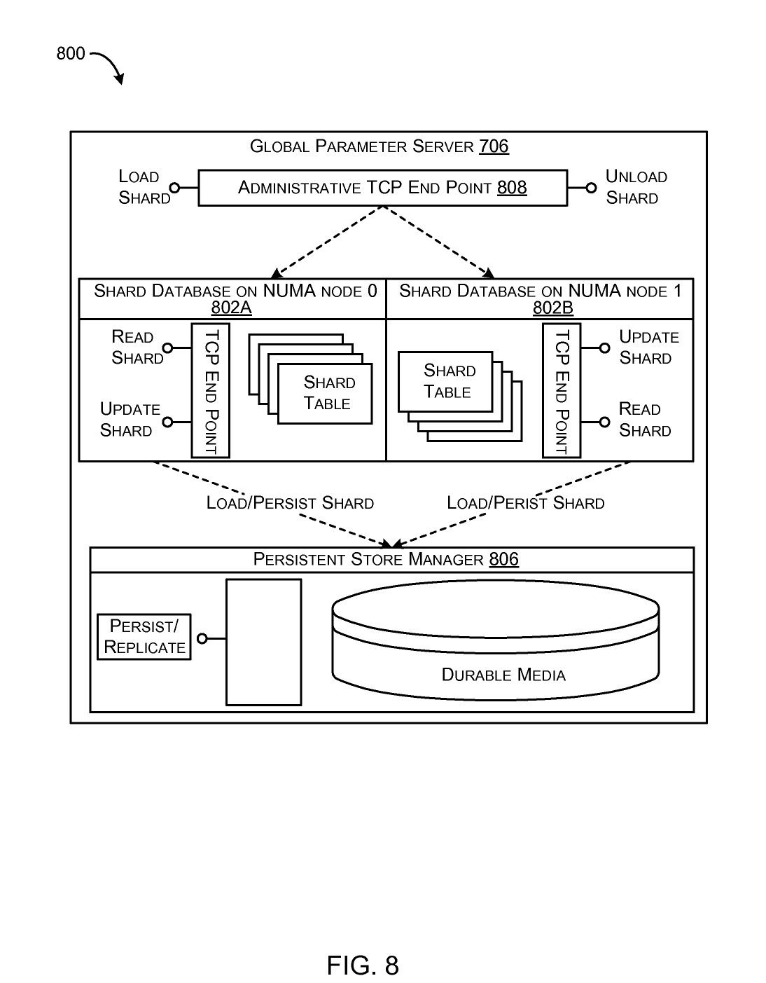

FIG. 8 is a diagram 800 of the global parameter sever(s) 706. As described above, the global parameter server(s) 706 may be in constant communication with the model training machines (e.g., Machine 1, Machine 2, etc.), asynchronously receiving updates to model parameters and sending the current weight values. These communications are illustrated by arrows 712 and 714.

### Throughput Optimizations

In at least one embodiment, the model parameters are divided into shards (e.g., 6 MB, 1 MB, etc.), which represents a contiguous partition of the parameter space, and these shards may be hashed into storage buckets that may be distributed equally among the global parameter server(s) 706. This partitioning improves the spatial locality of update processing while the distribution helps with load balancing. Further, updates may be opportunistically batched. This improves temporal locality and relieves pressure on the L3 cache by applying all updates in a batch to a block of parameters before moving to next block in the shard. The global parameter server(s) 702 use streaming SIMD extensions/advanced vector extensions (SSE/AVX) instructions for applying the update and processing is NUMA aware. Shards may be allocated on a specific NUMA nodes such as NUMA nodes 802A and 802B and the update processing for the shard may be localized to that NUMA node by assigning tasks to threads bound to the processors for the NUMA node by setting the appropriate processor masks. Lock free data structures may be used for queues and hash tables in high traffic execution paths to speed up network, update, and disk I/O processing. In addition, lock free memory allocation, where buffers are allocated from pools of specified size that vary in powers of 2 from 4 KB all the way to 32 MB, may be used. Small object allocations are satisfied by our global lock free pool for the object.

### Delayed Persistence

In at least one embodiment, durability may be decoupled from the update processing path to allow for high throughput serving to training nodes (e.g., replicas 704A-704N). Parameter storage is modeled as a write back cache, with dirty chunks flushed asynchronously in the back ground. The window of potential data loss is a function of the I/O throughput supported by the storage layer. This is tolerable due to resilient nature of underlying system as DNN models are capable of learning even in the presence of small amounts of lost updates. Further, these updates can be effectively recovered if needed by retraining the model on the appropriate input data. This delayed persistence may allow for compressed writes to durable storage as many updates can be folded into a single parameter update, due to additive nature of updates, between rounds of flushes. This allows update cycles to catch up to the current state of the parameter shard despite update cycles being slower.

### Fault Tolerant Operation

In at least one embodiment, there may be multiple copies of each parameter shard in the system and these are stored on different global parameter server(s) 706. The shard version that is designated as the primary is actively served while the two other copies are designated as secondary for fault tolerance. The global parameter server(s) 706 may be controlled by a set of parameter server (PS) controller machines that form a Paxos cluster. The controller maintains in its replicated state the shape of parameter server cluster that contains the mapping of shards and roles to global parameter server(s) 706. The clients (e.g., replicas 704A-704N) contact the controller to determine request routing for parameter shards. The controller hands out bucket assignments (primary role via a lease, secondary roles with primary lease information) to parameter servers and persists the lease information in its replicated state. The controller may also receive heart beats from global parameter server(s) 706 and relocate buckets from failed machines evenly to other active machines. This includes assigning new leases for buckets where the failed machine was the primary.

The global parameter server 706 that is the primary for a bucket may accept requests for parameter updates for all chunks in that bucket. The primary global parameter server 706 replicates changes to shards within a bucket to all secondary global parameter server(s) 706 via a 2 phase commit protocol. Each secondary global parameter server 706 checks the lease information of the bucket for a replicated request initiated by primary global parameter server 706 before committing. Each global parameter server 706 may send heart beats to the appropriate secondary global parameter server(s) 706 for all buckets for which it has been designated as primary global parameter server 706. Global parameter server(s) 706 that are secondary for a bucket may initiate a role change proposal to be a primary along with previous primary lease information to the controller in the event of prolonged absence of heart beat from the current primary. The controller will elect one of the secondary global parameter server(s) 706 to be the new primary, assigns a new lease for the bucket and propagates this information to all global parameter server(s) 706 involved for the bucket. Within a global parameter server 706, the on disk storage for a bucket is modeled as a log structured block store to optimize disk bandwidth for the write heavy work load.

### Communication Isolation

In at least one embodiment, global parameter server(s) 706 may have two or more network interface controllers (NICs). Parameter update processing from a client (training) perspective may be decoupled from persistence, and accordingly, the two paths may be isolated into their own NICs to maximize network bandwidth and minimize interference as shown in FIG. 8. In addition, administrative traffic may be isolated in the administrative TCP end point 808.

The example environments, systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation or embodiment, and the appearances of these phrases in various places in the specification are not necessarily all referring to the same implementation.

### Example Processes

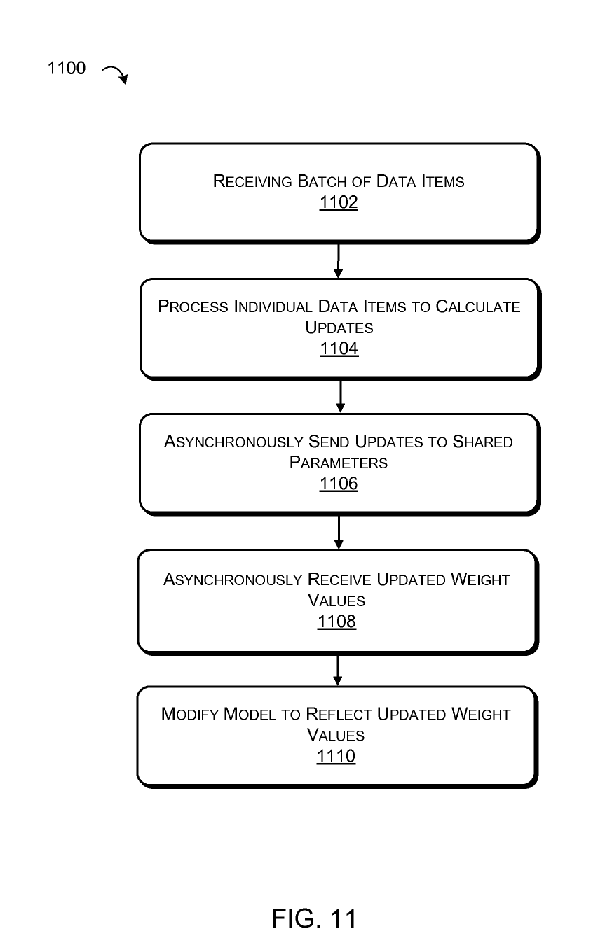

FIG. 11 is a flow diagram illustrating process 1100 for training a model based on asynchronous communication with shared parameters.

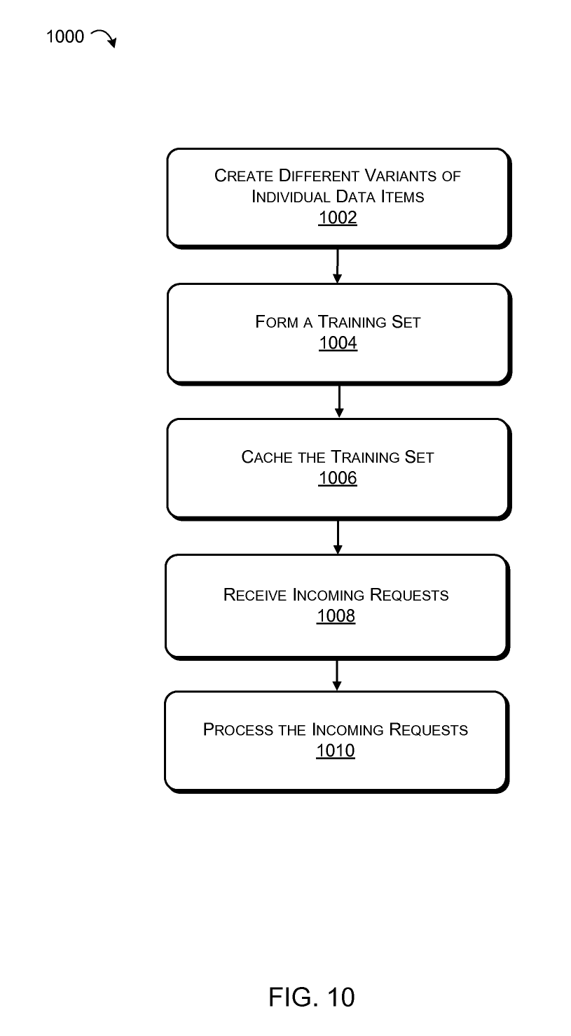

Block 1102 illustrates receiving a batch of data items, as described above. The deep learning training module 616 may receive the batch of data items from the data server(s) 702. The batch of data items may have been pre-processed in the data server(s) 702 as described in FIG. 10 below.

Block 1104 illustrates processing individual data items to calculate updates. The deep learning training module 616 may input the batch of data items into a model to calculate activation values, error terms, and/or weight updates.

Block 1106 illustrates asynchronously sending updates to shared parameters. The updates may include activation values, error terms, and/or weight updates, as described above. As described above, the individual replicas 704A-704N communicate independently with the global parameter server(s) 706 such that the deep learning training module 616 asynchronously sends the updates to the global parameter server(s) 706. The deep learning training module 616 may send the communications at different rates from different replicas 704A-704N. The rates may be based on predetermined time intervals or may be responsive to the replicas 704A-704N processing a predetermined number of the individual data items.

Block 1108 illustrates asynchronously receiving updated weight values. The global parameter server(s) 706 may provide updated weight values based on receiving updates from one or more replicas 704A-704N. The updated weight values take into account activation values, error terms, and/or weight updates from each of the individual replicas 704A-704N running asynchronously.

Block 1110 illustrates modifying the model to reflect the updated weight values, as described above. As described above, the deep learning training module 616 may calculate a model prediction error based at least in part on the updated individual weight values and the new updated weight values. The deep learning training module 616 may process subsequent batches of data items by repeating process 1100 until the model prediction error converges to a value below a predetermined threshold.

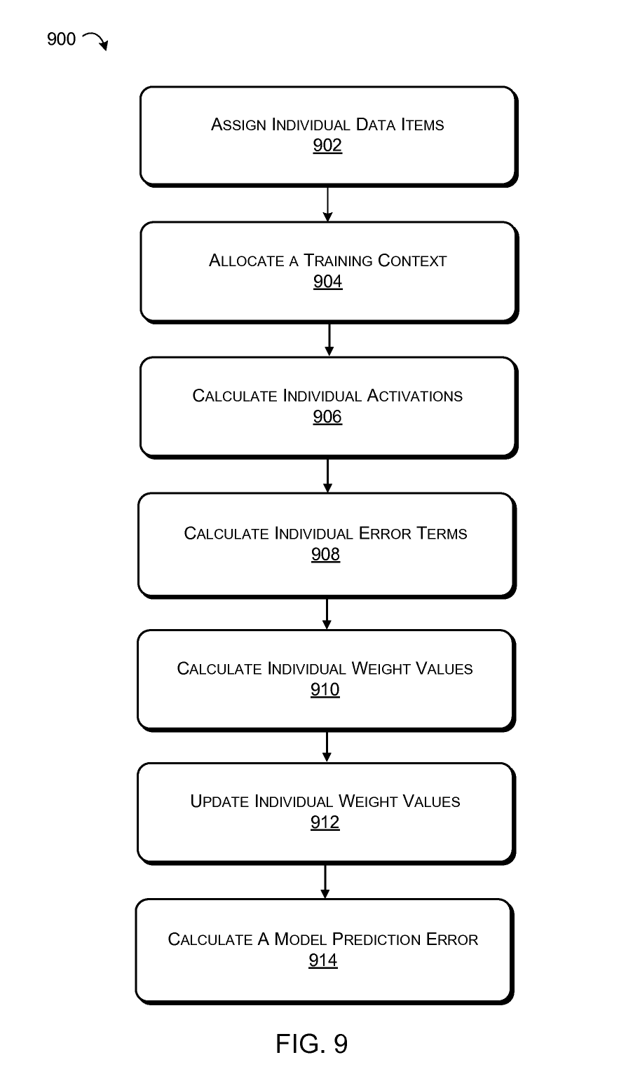

FIG. 9 is a flow diagram illustrating process 900 for providing input to model training machines organized as multiple replicas (e.g., replicas 704A-704N) that asynchronously update a shared model via global parameter server(s) 706.

Block 902 illustrates assigning individual data items of a plurality of data items to individual threads of a plurality of threads, as described above. As described above, the deep learning training module 616 may assign individual data items to the individual threads based at least in part on the individual threads sharing a same model weight.

Block 904 illustrates allocating a training context for feed-forward evaluation and back propagation. The deep learning training module 616 may perform such allocating as described above.

Block 906 illustrates calculating individual activation terms associated with neurons in fully connected layers of the model at least in p art based on the feed-forward evaluation.

Block 908 illustrates calculating individual error terms associated with neurons in fully connected layers of the model at least in p art based on the back propagation.

Block 910 illustrates calculating individual weight values for the individual data items, based at least in part on the individual activations and the individual error terms. In some embodiments, the individual weight values may be calculated independent of the individual activation and error terms, as described above.

Block 912 illustrates updating the individual weight values to generate updated individual weight values. The updating may be the result of asynchronous communication between the replicas 704A-704N and the global parameter server(s) 706. As described above, the communications may be asynchronous such that individual replicas 704A-704N communicate independently with the global parameter server(s) 706. The different replicas 704A-704N may communicate at different rates with the global parameter server(s) 706. The rates may be based on predetermined time intervals or may be responsive to the replicas 704A-704N processing a predetermined number of the individual data items.

Block 914 illustrates calculating a model prediction error based at least in part on the updated individual weight values, as described above.

FIG. 10 is a flow diagram illustrating process 1000 for creating different variants of individual data items. The process 1000 may be executed in the data server(s) 702.

Block 1002 illustrates creating different variants of individual data items by transforming the individual data items. As described above, the data server(s) 702 may transform the individual data items. Transforming includes translating, rotating, and/or reflecting.

Block 1004 illustrates forming a training set representing the different variants of the individual data items.

Block 1006 illustrates caching the training set in an image cache.

Block 1008 illustrates receiving incoming requests for data items. The data server(s) 702 may receive requests asynchronously from individual replicas 704A-704N. The requests may be received at different rates from different replicas 704A-704N. The rates may be based on predetermined time intervals or may be responsive to the replicas 704A-704N processing a predetermined number of the individual data items.

Block 1010 illustrates processing the incoming requests using asynchronous input/output. As described above, the data server(s) 702 may process the incoming requests asynchronously based on individual rates associated with individual replicas 704A-704N.

A. A system comprising: a computer-readable media storing at least two modules; a processing unit operably coupled to the computer-readable media, the processing unit adapted to execute the at least two modules comprising: a model module configured for storing a portion of a model; and a deep learning training module configured for communicating with the model module and asynchronously sending updates to parameters shared by the model.

B. A system as paragraph A recites, further comprising one or more data servers configured to pre-process data items and store the pre-processed data items, wherein pre-processing the data items comprises creating variants of the data items.

C. A system as either paragraph A or B recites, wherein the deep learning training module is further configured to asynchronously receive batches of pre-processed data items from one or more data servers; and provide the batches of the pre-processed data items as input to the model module.

D. A system as any of paragraphs A-C recite, wherein asynchronously sending the updates comprises sending associative and commutative weight updates to the parameters shared by the model.

E. A system as any of paragraphs A-D recite, wherein asynchronously sending the updates comprises sending updates including activation terms and error terms to the parameters shared by the model, the activation terms representing an output of individual neurons in a layer of the model resulting from feed-forward evaluation and the error terms representing computations associated with the individual neurons resulting from back-propagation of the activation terms.

F. A system as any of paragraphs A-E recite, further comprising one or more parameter servers configured to: store the parameters shared by the model; receive activation terms and error terms for updating the parameters; collect the activation terms and the error terms; calculate updated weight values associated with the parameters based at least partly on the collected activation terms and error terms; and send the updated weight values to the deep learning training module.

G. A system as any of paragraphs A-F recite, wherein the deep learning training module is further configured to: asynchronously receive updated weight values based on the updates sent to the parameters shared by the model; and provide the updated weight values to the model module to update the portion of the model.

H. A system as any of paragraphs A-G recite, wherein the portion of the model includes individual neurons arranged in layers, individual neurons in a first layer having vertical proximities within a predetermined threshold to individual neurons in neighboring layers.

I. A method comprising: receiving a batch of data items; processing individual data items of the batch of data items, the processing comprising applying a model to the batch of data items to calculate updates; asynchronously sending the updates to shared parameters associated with the model; asynchronously receiving updated weight values based on the updates to the shared parameters; and modifying the model to reflect the updated weight values.

J. A method as paragraph I recites, wherein the processing the individual data items further comprises assigning the individual data items to individual threads of a plurality of threads based at least in part on the individual threads sharing a same model weight; allocating a training context for feed-forward evaluation and back-propagation; calculating weight updates associated with the convolutional layers of the model; and calculating activation terms and error terms associated with neurons in fully connected layers of the model, the activation terms and error terms based at least in part on the feed-forward evaluation and back-propagation.

K. A method as either paragraph I or J recites, wherein asynchronously sending the updates to the shared parameters comprises sending the updates responsive to processing a predetermined number of the individual data items.

L. A method as any of paragraphs I-K recite, wherein asynchronously sending the updates to the shared parameters comprises sending the updates in predetermined time intervals.

M. A method as any of paragraphs I-L recite, wherein the updates are associative and commutative and are aggregated before being applied to update the shared parameters.

N. A method as any of paragraphs I-M recite, wherein the batch of data items comprises a first batch of data items and the method further comprises: receiving a second batch of data items; processing individual data items of the second batch of data items, the processing comprising applying the model to the second batch of data items to calculate new updates; asynchronously sending the new updates to the shared parameters; asynchronously receiving new updated weight values based on the new updates to the shared parameters; and modifying the model to reflect the new updated weight values.

O. A method as paragraph N recites, further comprising calculating a model prediction error based at least in part on the updated individual weight values and the new updated weight values.

P. A method as any of paragraphs I-O recite, further comprising processing subsequent batches of data items until the model prediction error converges to a value below a predetermined threshold.

Q. One or more computer-readable storage media encoded with instructions that, when executed by a processor, configure a computer to perform a method as recited in any of paragraphs I-P.

R. A system comprising: a computer-readable media; and a processing unit operably coupled to the computer-readable media, the processing unit adapted to execute a method as recited in any of paragraphs I-P.

S. A method comprising: arranging computing devices into groups of computing devices, individual groups associated with a model; and partitioning the model across the computing devices in each individual group, the partitioning comprising vertically partitioning the model such that neurons in a layer of the model have vertical proximities within a predetermined threshold to neurons in neighboring layers of the model.

T. A method as paragraph S recites, wherein partitioning the model across the computing devices further comprises partitioning the model to fit in an L3 cache of the computing devices.

U. A method as either paragraph S or T recites, wherein arranging the groups comprises arranging the groups such that a first group sends updates to shared parameters associated with the model at a first rate and a second group sends additional updates to the shared parameters at a second rate.

V. A method as paragraph U recites, wherein arranging the groups further comprises arranging the groups such that the first group sends the updates without knowledge of the second group sending the additional updates.

W. One or more computer-readable storage media encoded with instructions that, when executed by a processor, configure a computer to perform a method as recited in any of paragraphs S-V.

X. A system comprising: a computer-readable media; and a processing unit operably coupled to the computer-readable media, the processing unit adapted to execute a method as recited in any of paragraphs S-V.

### CONCLUSION

In closing, although the various embodiments have been described in language specific to structural features and/or methodical acts, it is to be understood that the subject matter defined in the appended representations is not necessarily limited to the specific features or acts described. Rather, the specific features and acts are disclosed as example forms of implementing the claimed subject matter.

What is claimed is:

1. A system comprising:
a computer-readable media storing at least two modules;
a processing unit operably coupled to the computer-readable media, the processing unit adapted to execute the at least two modules, the at least two modules comprising:
a model module configured to store a portion of a model; and
a deep learning training module configured to communicate with the model module and asynchronously sending updates to parameters shared by the model.

2. A system as claim 1 recites, further comprising one or more data servers configured to pre-process data items and store the pre-processed data items, wherein pre-processing the data items comprises creating variants of the data items.

3. A system as claim 2 recites, wherein the deep learning training module is further configured to:
asynchronously receive batches of the pre-processed data items from the one or more data servers; and
provide the batches of the pre-processed data items as input to the model module.

4. A system as claim 1 recites, wherein asynchronously sending the updates comprises sending associative and commutative weight updates to the parameters shared by the model.

5. A system as claim 1 recites, wherein asynchronously sending the updates comprises sending updates including activation terms and error terms to the parameters shared by the model, the activation terms representing an output of individual neurons in a layer of the model resulting from feed-forward evaluation and the error terms representing computations associated with the individual neurons resulting from back-propagation of the activation terms.

6. A system as claim 5 recites, further comprising one or more parameter servers configured to:
store the parameters shared by the model;
receive the activation terms and the error terms for updating the parameters;
collect the activation terms and the error terms;
calculate updated weight values associated with the parameters based at least partly on the collected activation terms and error terms; and
send the updated weight values to the deep learning training module.

7. A system as claim 1 recites, wherein the deep learning training module is further configured to:
asynchronously receive updated weight values based on the updates sent to the parameters shared by the model; and
provide the updated weight values to the model module to update the portion of the model.

8. A system as claim 1 recites, wherein the portion of the model includes individual neurons arranged in layers, individual neurons in a first layer having vertical proximities within a predetermined threshold to individual neurons in neighboring layers.

9. One or more computer-readable storage media encoded with instructions that, when executed by a processor, configure a computer to perform acts comprising:
receiving a batch of data items;
processing individual data items of the batch of data items, the processing comprising applying a model to the batch of data items to calculate updates;
asynchronously sending the updates to shared parameters associated with the model;
asynchronously receiving updated weight values based on the updates to the shared parameters; and
modifying the model to reflect the updated weight values.

10. One or more computer-readable storage media as claim 9 recites, wherein the processing the individual data items further comprises:
assigning the individual data items to individual threads of a plurality of threads based at least in part on the individual threads sharing a same model weight;
allocating a training context for feed-forward evaluation and back-propagation;
calculating weight updates associated with the convolutional layers of the model; and
calculating activation terms and error terms associated with neurons in fully connected layers of the model, the activation terms and error terms based at least in part on the feed-forward evaluation and back-propagation.

11. One or more computer-readable storage media as claim 9 recites, wherein asynchronously sending the updates to the shared parameters comprises sending the updates responsive to processing a predetermined number of the individual data items.

12. One or more computer-readable storage media as claim 9 recites, wherein asynchronously sending the updates to the shared parameters comprises sending the updates in predetermined time intervals.

13. One or more computer-readable storage media as claim 9 recites, wherein the updates are associative and commutative and are aggregated before being applied to update the shared parameters.

14. One or more computer-readable storage media as claim 9 recites, wherein the batch of data items comprises a first batch of data items and the method further comprises:
receiving a second batch of data items;
processing individual data items of the second batch of data items, the processing comprising applying the model to the second batch of data items to calculate new updates;
asynchronously sending the new updates to the shared parameters;
asynchronously receiving new updated weight values based on the new updates to the shared parameters; and
modifying the model to reflect the new updated weight values.

15. One or more computer-readable storage media as claim 14 recites, further comprising calculating a model prediction error based at least in part on the updated individual weight values and the new updated weight values.

16. One or more computer-readable storage media as claim 15 recites, further comprising processing subsequent batches of data items until the model prediction error converges to a value below a predetermined threshold.

17. A method comprising:
arranging computing devices into groups of computing devices, individual groups associated with a model; and
partitioning the model across the computing devices in each individual group, the partitioning comprising vertically partitioning the model such that neurons in a layer of the model have vertical proximities within a predetermined threshold to neurons in neighboring layers of the model.

18. A method as claim 17 recites, wherein partitioning the model across the computing devices further comprises partitioning the model to fit in an L3 cache of the computing devices.

19. A method as claim 17 recites, wherein arranging the groups comprises arranging the groups such that a first group sends updates to shared parameters associated with the model at a first rate and a second group sends additional updates to the shared parameters at a second rate.

20. A method as claim 19 recites, wherein arranging the groups further comprises arranging the groups such that the first group sends the updates without knowledge of the second group sending the additional updates.
